(19) United States
(12) Patent Application Publication
(10) Pub. No.: US 2019/0242526 A1
(43) Pub. Date: Aug. 8, 2019

(54) Cryogenic Liquid Containment And Transfer

(71) Applicant: PEERLESS INDUSTRIAL SYSTEMS PTY LTD, Victoria (AU)

(72) Inventor: Nick SUBOTSCH, Victoria (AU)

(21) Appl. No.: 16/342,993

(22) PCT Filed: Oct. 19, 2017
(86) PCT No.: PCT/AU2017/051131

§ 371 Date: Apr. 18, 2019

(30) Foreign Application Priority Data
Oct. 19, 2016 (AU) 2016904242

(51) Int. Cl. F17C 3/06; F17C 3/02

(52) U.S. Cl. CPC F17C 3/06; F17C 3/022; F17C 2203/0345; F17C 2203/0341; F17C 2203/0604; F17C 2203/0619; F17C 2203/0648; F17C 2203/0663; F17C 2203/0678; F17C 2221/033; F17C 2223/033; F17C 2270/0134; F17C 2203/066

(57) ABSTRACT

Vessels, wall structures, transfer hoses and systems for storing and transferring liquid cryogens are provided and are based on an elastic layer comprised of a polymer fabric impregnated with a cured resin. The elastic layer is substantially impervious to liquid cryogen, for example LNG, and retains elastic properties at typical cryogenic temperatures.

### FIELD

The present disclosure relates to the containment and transfer of cryogenic liquids, including liquefied natural gas (LNG). In particular, the present disclosure relates to vessels, transfer hose liners, systems and methods, comprising an elastic polymer fabric wherein said fabric provides an effective barrier to a contained cryogen.

### BACKGROUND

Liquefied natural gas (LNG) is natural gas that has been converted to liquid form for ease of storage or transport. LNG takes up about 1/600th the volume of natural gas in the gaseous state. The liquefaction process involves condensation into a liquid at close to atmospheric pressure by cooling it to approximately −162° C. LNG achieves a higher reduction in volume than compressed natural gas (CNG) so that the volumetric energy density of LNG is 2.4 times greater than that of CNG or 60 percent that of diesel fuel. This makes LNG cost efficient to transport over long distances where pipelines do not exist. Specially designed cryogenic sea vessels (LNG carriers) or cryogenic road tankers are used for its transport. LNG is principally used for transporting natural gas to markets, where it is regasified and distributed as pipeline natural gas. Its relatively high cost of production and the need to store it in expensive cryogenic tanks have hindered widespread commercial use. Despite these drawbacks, on an energy basis LNG production is expected to hit 10% of the global crude production by 2020. Recent worldwide growth in natural gas consumption has led to a significant change in LNG supply and storage requirements. To meet the new demand, a broad range of innovative solutions including small and mid-scale developments to meet regional requirements, and large LNG Hubs are under consideration.

However, LNG containment facilities are expensive to construct and in recent years the industry has focused on the following areas:
improving cost effectiveness;
improving land area utilization;
providing larger tanks to accommodate the progressive increase in the gross capacity of ocean going LNG carriers;
reducing construction schedules; and
reducing carbon footprint.

Two primary systems presently exist for the storage of LNG. These are typically referred to as “Full Containment” and “Membrane” systems. The Full Containment system has become the most common technology employed for above ground LNG tank applications, fulfilling the requirements of many existing projects. However, there is recent heightened interest in Membrane technology as a strong contender for new project specifications.

FIG. 1 is a cross-sectional view of a typical prior art Full Containment LNG storage tank. For this containment technology the primary container is a thick 9% nickel welded steel tank which has adequate ductility at −162° C. The secondary container is a pre-stressed concrete tank equipped with a thermal corner protection. The space between the primary and secondary containers is filled with thermal insulation. The primary and secondary containers each possess separate hydrostatic stability and are thus referred to as self-standing. The secondary container provides protection should the inner wall fail, and also serves as defence against external events. Referring to FIG. 1 there is highlighted the primary container wall (1) (9% Ni steel); bottom insulation (2) (for example, load bearing rigid cellular glass); a slab (3) (reinforced concrete); insulated suspended deck (4) (typically aluminum and fibreglass); hemispherical dome roof (5) (reinforced concrete); sidewalls (6) (pre-stressed concrete) and wall insulation (7) (for example loose fill perlite of 1 m thickness).

The inner faces of items (3), (5) and (6) in FIG. 1 is covered by a carbon steel liner (8) ensuring gas tightness. The thermal corner protection extends about five meters above the bottom slab and protects the wall-to-base joint. The annular space (7) is connected to the vapour space on the tank and is thus filled with methane gas.

FIG. 2 is a cross-sectional view of a typical prior art Membrane system LNG storage tank. For this containment technology the primary container is a thin stainless steel corrugated membrane. The secondary container is a pre-stressed concrete tank equipped with a thermal corner protection. The space between the primary and secondary containers is filled with thermal insulation. This concept is based on the separation of structural and fluid tightness functions. The primary container ensures liquid and gas tightness. The secondary container provides the hydrostatic stability. The load bearing insulation system transfers hydrostatic loads to the secondary container and limits the heat entrances to meet specified boil-off rate criteria.

Referring to FIG. 2 there is highlighted a stainless steel corrugated membrane (1) (1.2 mm thick); sidewalls (pre-stressed concrete) (2); bottom insulation (3) (load bearing polyurethane/40 cm thick); slab (4) (reinforced concrete); insulated suspended deck (5) (typically aluminum and fibreglass); hemispherical dome roof (6) (reinforced concrete); wall insulation (7) (load bearing polyurethane/40 cm thick).

The insulation space between the membrane and the concrete vessel is isolated from the vapour space of the tank. A nitrogen breathing system operates on the space to monitor the methane concentration and keep the pressure within normal operating bounds. The nitrogen system can be used to purge the insulation space in the unlikely event of a leak.

Despite the widespread use of both Full Containment and Membrane systems, issues with current LNG storage still exist. Full Containment systems are expensive to manufacture, requiring expert labour in fabricating the 9% nickel steel inner tank. While the membrane system does use significantly less metal and insulation than the Full Containment system, both systems use large amounts of expensive construction materials.

WO 2010/048664 discloses a polymer fabric having properties that accommodate movement at or adjacent one or more respective surfaces without compromising structural integrity of the or each surface when the polymer fabric is affixed thereon. The document also discloses the use of the polymer fabric as an internal lining of liquid gas, such as LNG or LPG, containers to contain and/or insulate the cargo. The polymer fabric lines the internal metal surface of the container.

Cryogenic liquid transfer systems, including LNG transfer systems, typically involve flexible hoses made of composite layers. These hoses are primarily utilised to transfer LNG ship-to-ship or ship-to shore. The hoses may be up to 20 metres long and 30 cm in diameter. They are typically constructed from metal mesh and comprise various polymer layers, such as polyethylene, polyester or polyamide. The hoses must remain flexible within an operating temperature range of 40° C. to cryogenic temperatures and withstand very high flow rates. During transfer of LNG temperature fluctuations may result in the formation of gas bubbles. Further, due to high turbulence levels close to the inner metal mesh construction, gas bubbles may also form. This is undesirable as it can impact pressure loss across the hose.

Due to the low temperatures involved in cryogenic liquid handling condensation of moisture on equipment and facilities is an ongoing problem, particularly in regard to corrosion of metal parts.

Accordingly, it would be desirable to provide alternative designs for LNG containment and transfer systems that address one or more of the above highlighted problems and deficiencies.

The reference in this specification to any prior publication (or information derived from it), or to any matter which is known, is not, and should not be taken as an acknowledgement or admission or any form of suggestion that that prior publication (or information derived from it) or known matter forms part of the common general knowledge in the field of endeavour to which this specification relates.

### SUMMARY

In one aspect there is provided a composite wall structure for a cryogenic liquid storage vessel, said wall structure comprising the following layers:
(a) an elastic inner layer comprising a polymer fabric impregnated with a cured resin;
(b) a structural layer; and
(c) an insulating layer disposed between the elastic inner layer and the structural layer;
   wherein, in use, the elastic inner layer is in direct contact with a cryogenic liquid.

The cryogenic liquid may be hydrogen, helium, nitrogen, oxygen, methane, liquefied natural gas (LNG), helium, neon, argon, or krypton.

The structural layer may comprise one or more of concrete, reinforced concrete, carbon fibre, metals and alloys.

The insulating layer may comprise one or more non-combustible materials. Non-limiting examples of insulating materials include one or more of perlite, vermiculite, glass fibre and ceramic fibre.

The elastic inner layer may provide an impervious or substantially impervious barrier to a cryogenic liquid. By substantially impervious it may be meant that the permeation rate of a cryogen may meet international standards for containment of that particular cryogen. The elastic inner layer may be impervious or substantially impervious to hydrogen, helium, nitrogen, oxygen, methane, liquefied natural gas (LNG), helium, neon, argon, or krypton. The elastic inner layer may be impervious or substantially impervious to LNG.

The elastic inner layer may have an elasticity which accommodates movement of the wall structure or movement of any part of the container that may result in movement of the wall structure. The movement may be that which is caused by thermal expansion and contraction activity. The movement may be that which is caused by movement of the surroundings of the wall structure due to environmental effects, such as earthquakes or ground subsidence. The elastic inner layer elasticity is advantageous in maintaining the barrier integrity of the composite wall structure to cryogen.

The elastic inner layer may replace or substantially replace the 9% nickel metal wall in a Full Containment LNG system or stainless steel wall in a Membrane LNG system. This is highly advantageous from an economic standpoint.

The elastic inner layer may be in direct contact with the insulating layer.

The elastic inner layer may have elasticity such that the layer returns substantially to its original condition after removal of a tensile load.

The elastic inner layer may have an elasticity of at least 100%, or at least 200%, or at least 400%, or at least 600% or at least 800%.

The elastic inner layer retains elastic properties at low temperatures. It has been found that the elastic inner layer may retain elastic properties even at liquid nitrogen temperatures. Elasticities of 200% or greater may be observed at −196° C. Such retention of elasticity at low temperature is clearly advantageous in applications where the inner layer is exposed to low temperature in use, such as that found in cryogenic liquid storage, particularly in LNG storage.

The elastic inner layer may have comparable elastic properties in both lateral and longitudinal directions.

The elastic inner layer may have properties of flexibility, that is, the elastic layer may be able to bend without cracking. The elastic inner layer may be both elastic and flexible.

The elastic inner layer may have adhesive qualities, to aid in adhesion to a surface. For example, adhesion to the surface of an insulating layer or another layer.

The polymer fabric may comprise a plurality of elastomeric fibres. The elastomeric fibres may comprise any natural or synthetic polymer or mixtures thereof that at ambient temperature may be stretched and/or expanded to greater than the original length of the fibre when the fibre is subjected to a tensile load and, preferably, return substantially to the original condition after removal of a tensile load.

The elastomeric fibres may provide structural reinforcement to the polymer fabric. The elastomeric fibres may provide tear resistance to the polymer fabric. The elastomeric fibres may provide resistance to crack propagation perpendicular to the plane of said polymer fabric.

The elastic inner layer, through its elastic properties, advantageously retains structural integrity in response to movement of the wall structure. Accordingly, the elastic inner layer may overcome disadvantages associated with the heretofore employed metal walls in cryogenic liquid storage vessels.

The elastic inner layer may have a thickness of less than 5000 microns, or less than 4000 microns, or less than 3000 microns, or less than 2000 microns, or less than 1000 microns, or less than 800 microns, or less than 600 microns, or less than 400 microns, or less than 200 microns. The elastic inner layer may have a thickness from 100 to 1000 microns or a thickness from 200 to 800 microns.

The cured resin may have elastic properties. The cured resin may be derived from liquid resins or liquid binders. Non-limiting examples of cured resins comprise polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof.

Non-limiting examples of suitable elastomeric fibres that may be used are one or more of spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), or polytetrafluoroethylene (PTFE). These may be optionally combined with one or more synthetic or natural fibres, for example, nylon, polypropylene or polyethylene. Denier of the individual filaments of the elastomeric fibres may be selected depending on the intended use of the elastic layer.

A primer material may be applied to the internal surface of the wall structure, for example, the insulation layer, to improve fixation of the elastic inner layer to the surface.

The elastic inner layer may be coated with a barrier forming material to modify the resistance to chemicals, UV radiation or other external influences. Preferably, the elastic properties of the barrier forming material are chosen to match those of the elastic inner layer.

The cured resin may be formed from resins or binders that cure at ambient temperatures in the absence of applied heat, UV radiation or an external catalyst. The cured resin desirably has good flexibility qualities while also having resilience.

The skilled artisan will appreciate that the wall structure of the present disclosure is not limited to vertical containment walls but also to the roofs or floors of cryogenic containment systems.

The skilled artisan will also appreciate that the wall structure of the present disclosure may comprise one or more further layers, for example, structural or insulation layers.

In another aspect there is provided a cryogenic liquid storage vessel comprising the composite wall structure according to any one of the herein disclosed embodiments.

In another aspect there is provided a cryogenic liquid storage vessel comprising the composite wall structure according to any one of the herein disclosed embodiments and further comprising one or more cryogens stored therein.

In another aspect there is provided a cryogenic storage vessel, wherein said storage vessel has at least one inner surface coated with an elastic inner layer, said elastic inner layer comprising a polymer fabric impregnated with a cured resin. The elastic inner layer may comprise any one or more of the herein disclosed embodiments.

In any of the herein disclosed aspects the cryogenic storage vessel may be a Full Containment vessel or a Membrane vessel. The cryogenic liquid may be LNG.

In another aspect there is provided a cryogenic liquid storage system, said system comprising a plurality of cryogenic liquid storage vessels as herein disclosed.

The cryogenic liquid storage vessels may be located on land or may be located on a transport vessel, for example, a ship, a truck or a train or combinations thereof. The system may comprise storage vessels both as fixed storage vessels on land and mobile storage vessels on, for example, a ship, a truck or a train or combinations thereof.

In another aspect there is provided an elastic inner layer for a cryogenic liquid transfer hose, said elastic inner layer comprising a polymer fabric impregnated with a cured resin as disclosed herein.

In another aspect there is provided a cryogenic liquid transfer hose, said transfer hose comprising a wall structure, said wall structure comprising the following layers:
(a) an elastic inner layer comprising a polymer fabric impregnated with a cured resin; and
(b) at least one insulating layer, wherein, in use, the elastic layer is in direct contact with a cryogenic liquid.

The elastic layer and the inner layer may comprise any one or more of the embodiments as herein disclosed.

In another aspect there is provided a method of lining a cryogenic liquid transfer hose comprising:
a) introducing a cured in place layer into said hose; said layer comprising:
   i. an elastic polymer fabric; and
   ii. a resin; and
b) allowing the resin to cure.

The polymer fabric may be continuously impregnated with resin and the resulting impregnated fabric continuously introduced into the hose.

In an alternate embodiment the method comprises pre-impregnating a continuous portion of polymer fabric with a resin, packing the resulting resin impregnated polymer fabric so as to preserve it in an uncured state for future use and removing the uncured impregnated polymer fabric from the packing, introducing the uncured impregnated polymer fabric into a hose and allowing the uncured impregnated polymer fabric to cure and form the elastic layer without the need for further additives or processing.

In this particular embodiment, it is desirable to provide a resin with appropriate viscosity such that upon opening of the package resin drainage and subsequent loss may be avoided. In this respect, resins having relatively higher viscosities and preferably thixatropic properties may be advantageously utilised.

In another embodiment heat or one or more suitable additives may be utilised to enhance curing.

In an alternate embodiment the uncured impregnated polymer fabric may be stored at low temperature until required for use.

The resulting elastic inner layer is a membrane or liner which advantageously exhibits properties of elasticity and preferably flexibility and/or tear resistance as herein disclosed.

The resulting elastic inner layer may advantageously adhere directly onto a surface and provide a continuous singular unit of membrane or liner, uninterrupted by joins or seams which can compromise the structural integrity and strength of the layer. A single unit of liner or membrane may also be preformed in any suitable shape or configuration prior to transporting and arrival at the site of application.

In another aspect there is provided an elastic outer layer for a cryogenic liquid transfer hose, said elastic outer layer comprising a polymer fabric impregnated with a cured resin according to any one of the herein disclosed embodiments.

In another aspect there is provided a cryogenic liquid transfer hose, said transfer hose comprising a wall structure, said wall structure comprising the following layers:
(a) an elastic outer layer comprising a polymer fabric impregnated with a cured resin; and
(b) at least one insulating layer, wherein, in use, the elastic layer protects other layers of the wall structure from moisture.

In another aspect there is provided a cryogenic liquid transfer hose, said transfer hose comprising a wall structure, said wall structure comprising the following layers:
(a) an elastic inner layer comprising a polymer fabric impregnated with a cured resin;
(b) at least one insulating layer; and
(c) an elastic outer layer comprising a polymer fabric impregnated with a cured resin,
   wherein, in use, the elastic inner layer is in direct contact with a cryogenic liquid and the elastic outer layer protects other layers of the wall structure from moisture.

In any of the herein disclosed aspects the cryogenic liquid transfer hose may comprise one or more other layers, for example metal or metal composite layers.

In another aspect there is provided a method of protecting or insulating components of a cryogenic liquid storage or transfer facility comprising applying an elastic layer, said elastic layer comprising the herein disclosed polymer fabric impregnated with a cured resin, to the outside surface of a component such that the elastic layer provides an impervious or substantially impervious barrier to moisture.

In another aspect there is provided a cryogenic liquid storage system, said system comprising a plurality of cryogenic liquid transfer hoses as herein disclosed.

The cryogenic liquid transfer hoses may be located on land or may be located on a transport vessel, for example, a ship, a truck or a train. The cryogenic liquid transfer hoses may link cryogenic liquid storage vessels on land with one or more cryogenic storage vessels on a truck, a train or a ship.

In another aspect there is provided a system for storing and transferring liquid cryogen comprising:
(a) one or more cryogenic liquid storage vessels as disclosed herein; and
(b) one or more cryogenic liquid transfer hoses as disclosed herein.

The system may further comprise one or more further cryogenic liquid storage vessels, that is, one or more vessels not according to the present disclosure.

The system may further comprise one or more further cryogenic liquid transfer hoses, that is, one or more hoses not according to the present disclosure.

In some embodiments the cryogenic liquid storage vessels according to the present disclosure may be fixed vessels, that is, they may be fixed in a particular location.

In some embodiments the cryogenic liquid storage vessels according to the present disclosure may be mobile, that is, they may be located on a truck, a train or a ship.

In any one or more of the above disclosed aspects the polymer fabric preferably comprises nylon and one or more of spandex, Lycra® or elastane and the resin comprises a polyurethane.

### BRIEF DESCRIPTION OF THE DRAWINGS

FIG. 1 illustrates the wall structure of an exemplary prior art Full Containment LNG storage tank.

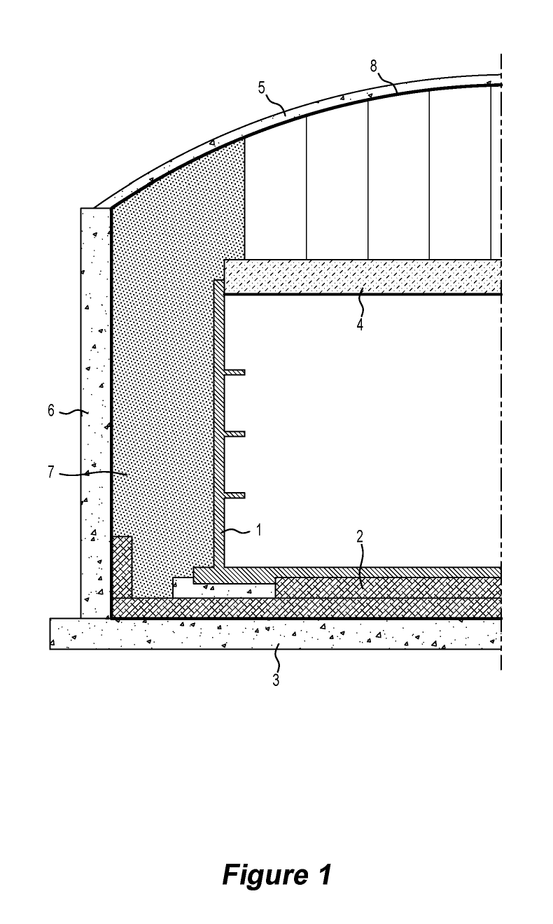

FIG. 2 illustrates the wall structure of an exemplary prior art Membrane LNG storage tank.

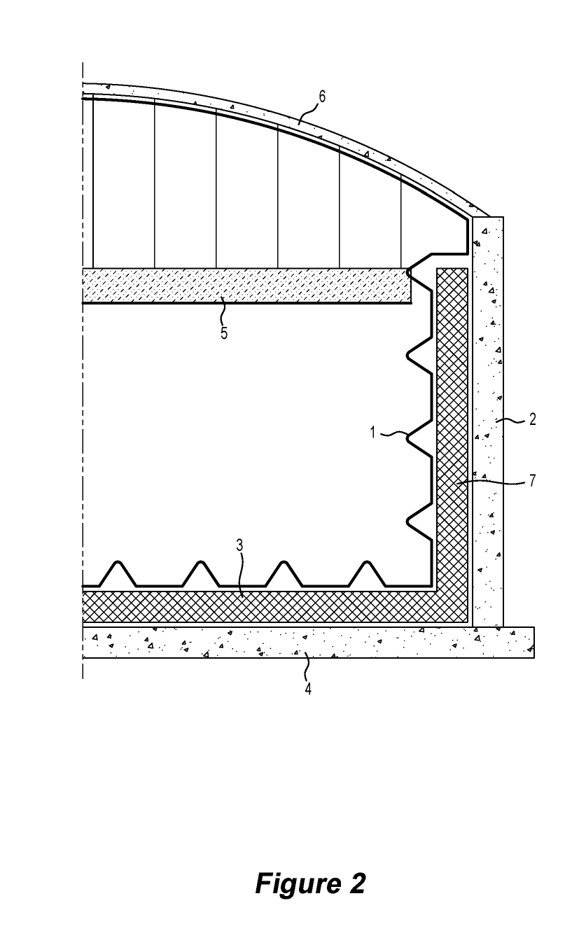

FIG. 3 illustrates a wall structure of a cryogenic liquid containment vessel according to an embodiment of the present disclosure.

FIG. 4 illustrates a cryogenic liquid transfer hose according to an embodiment of the present disclosure.

FIG. 5 illustrates a cryogenic liquid transfer hose according to another embodiment of the present disclosure.

### DESCRIPTION OF EXEMPLARY EMBODIMENTS

Throughout this specification, use of the terms “comprises” or “comprising” or grammatical variations thereon shall be taken to specify the presence of stated features, integers, steps or components but does not preclude the presence or addition of one or more other features, integers, steps, components or groups thereof not specifically mentioned.

Before the present structures, components, systems and/or methods are disclosed and described, it is to be understood that unless otherwise indicated this invention is not limited to specific structures, components, methods, or the like, as such may vary, unless otherwise specified. It is also to be understood that the terminology used herein is for the purpose of describing particular embodiments only and is not intended to be limiting.

It must also be noted that, as used in the specification and the appended claims, the singular forms ‘a’, ‘an’ and ‘the’ include plural referents unless otherwise specified. Thus, for example, reference to ‘an insulating layer’ may include more than one insulating layer, and the like.

Disclosed herein are advantageous structures, systems and methods for storing and transferring cryogenic liquids, particularly LNG. The structures, systems and methods are based on an elastic layer which is flexible, impervious or substantially impervious to cryogens Accordingly, advantageous cryogenic liquid storage systems may be constructed at a lower cost.

In an exemplary embodiment, there is provided a composite wall structure for a cryogenic liquid storage vessel, said wall structure comprising the following layers:
(a) an elastic inner layer comprising a polymer fabric impregnated with a cured resin;
(b) a structural layer comprising concrete; and
(c) an insulating layer disposed between the elastic inner layer and the structural layer;
   said insulating layer comprising one or more of perlite, vermiculite, glass fibres and ceramic fibres;
   wherein, in use, the elastic inner layer is in direct contact with a cryogenic liquid.

In another exemplary embodiment, there is provided a composite wall structure for a cryogenic liquid storage vessel, said wall structure comprising the following layers:
(a) an elastic inner layer comprising a polymer fabric impregnated with a cured resin;
(b) a structural layer comprising carbon fibre; and
(c) an insulating layer disposed between the elastic inner layer and the structural layer;
   said insulating layer comprising one or more of perlite, vermiculite, glass fibres and ceramic fibres;
   wherein, in use, the elastic inner layer is in direct contact with a cryogenic liquid.

In another exemplary embodiment, there is provided a composite wall structure for a cryogenic liquid storage vessel, said wall structure comprising the following layers:
(a) an elastic inner layer comprising a polymer fabric impregnated with a cured resin;
(b) a structural layer; and
(c) an insulating layer disposed between the elastic inner layer and the structural layer;
   wherein the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; wherein the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof; and
   wherein, in use, the elastic inner layer is in direct contact with a cryogenic liquid.

In another exemplary embodiment, there is provided a composite wall structure for a cryogenic liquid storage vessel, said wall structure comprising the following layers:
(a) an elastic inner layer comprising a polymer fabric impregnated with a cured resin;
(b) a structural layer comprising one or more of concrete, reinforced concrete, carbon fibre, metals and alloys; and
(c) an insulating layer disposed between the elastic inner layer and the structural layer, said insulating layer comprising one or more of perlite, vermiculite, glass fibre and ceramic fibre;
   wherein the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; wherein the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof; and
   wherein, in use, the elastic inner layer is in direct contact with a cryogenic liquid.

In another exemplary embodiment, there is provided a cryogenic liquid storage vessel said storage vessel having a composite wall structure, said wall structure comprising the following layers:
(a) an elastic inner layer comprising a polymer fabric impregnated with a cured resin;
(b) a structural layer comprising concrete; and
(c) an insulating layer disposed between the elastic inner layer and the structural layer;
   said insulating layer comprising one or more of perlite, vermiculite, glass fibres and ceramic fibres;
   wherein, in use, the elastic inner layer is in direct contact with a cryogenic liquid.

In another exemplary embodiment, there is provided a cryogenic liquid storage vessel said storage vessel having a composite wall structure, said wall structure comprising the following layers:
(a) an elastic inner layer comprising a polymer fabric impregnated with a cured resin;
(b) a structural layer comprising carbon fibre; and
(c) an insulating layer disposed between the elastic inner layer and the structural layer;
   said insulating layer comprising one or more of perlite, vermiculite, glass fibres and ceramic fibres;
   wherein, in use, the elastic inner layer is in direct contact with a cryogenic liquid.

In another exemplary embodiment, there is provided a cryogenic liquid storage vessel, said storage vessel having a composite wall structure, said wall structure comprising the following layers:
(a) an elastic inner layer comprising a polymer fabric impregnated with a cured resin;
(b) a structural layer; and
(c) an insulating layer disposed between the elastic inner layer and the structural layer;
   wherein the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; wherein the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof; and
   wherein, in use, the elastic inner layer is in direct contact with a cryogenic liquid.

In another exemplary embodiment, there is provided a cryogenic liquid storage vessel, said storage vessel having a composite wall structure, said wall structure comprising the following layers:
(a) an elastic inner layer comprising a polymer fabric impregnated with a cured resin;
(b) a structural layer comprising one or more of concrete, reinforced concrete, carbon fibre, metals and alloys; and
(c) an insulating layer disposed between the elastic inner layer and the structural layer,
   said insulating layer comprising one or more of perlite, vermiculite, glass fibre and ceramic fibre;
   wherein the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; wherein the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof; and
   wherein, in use, the elastic inner layer is in direct contact with a cryogenic liquid.

In any of the above disclosed exemplary embodiments the cryogenic liquid storage vessel further comprises one or more liquid cryogens.

In another exemplary embodiment there is provided a cryogenic liquid storage system comprising a plurality of cryogenic storage vessels as disclosed in the above exemplary embodiments.

In another exemplary embodiment there is provided a cryogenic liquid transfer hose, said transfer hose comprising a wall structure, said wall structure comprising the following layers:
(a) an elastic inner layer comprising a polymer fabric impregnated with a cured resin; and
(b) at least one insulating layer, wherein, in use, the elastic layer is in direct contact with a cryogenic liquid; and
   wherein the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; and wherein the cured resin comprises polyurethanes, polyureas, acrylic resins, polyester resins, silicone resins, fluorinated resins, for example polyvinylidene fluoride (PVDF) and polytetrafluoroethyiene (PTFE), fluorinated silicone resins, epoxy resins or combinations thereof.

In another exemplary embodiment there is provided a method of lining a cryogenic liquid transfer hose comprising:
a) introducing a cured in place layer into said hose; said layer comprising:
   i. an elastic polymer fabric; and
   ii. a resin; and
b) allowing the resin to cure;
   wherein the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; and wherein the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof.

In another exemplary embodiment there is provided a cryogenic liquid transfer hose, said transfer hose comprising a wall structure, said wall structure comprising the following layers:
(a) an elastic outer layer comprising a polymer fabric impregnated with a cured resin; and
(b) at least one insulating layer, wherein, in use, the elastic layer protects other layers of the wall structure from moisture;
   wherein the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; and wherein the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof.

In another exemplary embodiment there is provided a cryogenic liquid transfer hose, said transfer hose comprising a wall structure, said wall structure comprising the following layers:
(i) an elastic inner layer comprising a polymer fabric impregnated with a cured resin;
(ii) at least one insulating layer; and
(iii) an elastic outer layer comprising a polymer fabric impregnated with a cured resin,
   wherein, in use, the elastic inner layer is in direct contact with a cryogenic liquid and the elastic outer layer protects other layers of the wall structure from moisture; and
   wherein the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; and wherein the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof.

In another exemplary embodiment there is provided a system for storing and transferring liquid cryogen comprising:
(a) one or more cryogenic liquid storage vessels; and
(b) one or more cryogenic liquid transfer hoses;
   wherein said storage vessel has a composite wall structure, said wall structure comprising the following layers;
(i) an elastic inner layer comprising a polymer fabric impregnated with a cured resin;
(ii) a structural layer comprising one or more of concrete, reinforced concrete, carbon fibre, metals and alloys; and
(iii) an insulating layer disposed between the elastic inner layer and the structural layer; said insulating layer comprising one or more of perlite, vermiculite, glass fibres and ceramic fibres;
   wherein, in use, the elastic inner layer is in direct contact with a cryogenic liquid; and
   wherein said transfer hose comprising a wall structure, said wall structure comprising the following layers:
(i) an elastic inner layer comprising a polymer fabric impregnated with a cured resin; and
(ii) at least one insulating layer, wherein, in use, the elastic layer is in direct contact with a cryogenic liquid.

In another exemplary embodiment there is provided a system for storing and transferring liquid cryogen comprising:
(a) one or more cryogenic liquid storage vessels; and
(b) one or more cryogenic liquid transfer hoses;
   wherein said storage vessel has a composite wall structure, said wall structure comprising the following layers;
(i) an elastic inner layer comprising a polymer fabric impregnated with a cured resin;
(ii) a structural layer comprising concrete; and
(iii) an insulating layer disposed between the elastic inner layer and the structural layer; said insulating layer comprising one or more of perlite, vermiculite, glass fibres and ceramic fibres;
   wherein, in use, the elastic inner layer is in direct contact with a cryogenic liquid; and
   wherein said transfer hose comprising a wall structure, said wall structure comprising the following layers:
(i) an elastic inner layer comprising a polymer fabric impregnated with a cured resin; and
(ii) at least one insulating layer, wherein, in use, the elastic layer is in direct contact with a cryogenic liquid.

In another exemplary embodiment there is provided a system for storing and transferring liquid cryogen comprising:
(a) one or more cryogenic liquid storage vessels; and
(b) one or more cryogenic liquid transfer hoses;
   wherein said storage vessel has a composite wall structure, said wall structure comprising the following layers;
(i) an elastic inner layer comprising a polymer fabric impregnated with a cured resin;
(ii) a structural layer comprising carbon fibre; and
(iii) an insulating layer disposed between the elastic inner layer and the structural layer; said insulating layer comprising one or more of perlite, vermiculite, glass fibres and ceramic fibres;
   wherein, in use, the elastic inner layer is in direct contact with a cryogenic liquid; and
   wherein said transfer hose comprising a wall structure, said wall structure comprising the following layers:
(i) an elastic inner layer comprising a polymer fabric impregnated with a cured resin; and
(ii) at least one insulating layer, wherein, in use, the elastic layer is in direct contact with a cryogenic liquid.

In another exemplary embodiment there is provided a system for storing and transferring liquid cryogen comprising:
(a) one or more cryogenic liquid storage vessels; and
(b) one or more cryogenic liquid transfer hoses;
   wherein said storage vessel has a composite wall structure, said wall structure comprising the following layers;
(i) an elastic inner layer comprising a polymer fabric impregnated with a cured resin;
(ii) a structural layer comprising one or more of concrete, reinforced concrete, carbon fibre, metals and alloys; and
(iii) an insulating layer disposed between the elastic inner layer and the structural layer; said insulating layer comprising one or more of perlite, vermiculite, glass fibres and ceramic fibres;
   wherein, in use, the elastic inner layer is in direct contact with a cryogenic liquid; and
   wherein said transfer hose comprising a wall structure, said wall structure comprising the following layers:
(i) an elastic inner layer comprising a polymer fabric impregnated with a cured resin; and
(ii) at least one insulating layer, wherein, in use, the elastic layer is in direct contact with a cryogenic liquid;
   wherein, independently in each occurrence the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; and
   wherein independently in each occurrence the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof.

In another exemplary embodiment there is provided a system for storing and transferring liquid cryogen comprising:
(a) one or more cryogenic liquid storage vessels; and
(b) one or more cryogenic liquid transfer hoses;
   wherein said storage vessel has a composite wall structure, said wall structure comprising the following layers;
(i) an elastic inner layer comprising a polymer fabric impregnated with a cured resin;
(ii) a structural layer comprising one or more of concrete, reinforced concrete, carbon fibre, metals and alloys; and
(iii) an insulating layer disposed between the elastic inner layer and the structural layer; said insulating layer comprising one or more of perlite, vermiculite, glass fibres and ceramic fibres;
   wherein, in use, the elastic inner layer is in direct contact with a cryogenic liquid; and
   wherein said transfer hose comprising a wall structure, said wall structure comprising the following layers:
(i) an elastic inner layer comprising a polymer fabric impregnated with a cured resin;
(ii) at least one insulating layer; and
(iii) an elastic outer layer comprising a polymer fabric impregnated with a cured resin,
   wherein, in use, the elastic inner layer is in direct contact with a cryogenic liquid and the elastic outer layer protects other layers of the wall structure from moisture;
   wherein, independently in each occurrence the polymer fabric comprises spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), polytetrafluoroethylene (PTFE) or combinations thereof optionally combined with one or more synthetic or natural fibres, for example, nylon, polypropylene or polyethylene; and
   wherein independently in each occurrence the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof.

In any one or more of the above disclosed exemplary embodiments the polymer fabric preferably comprises nylon and one or more of spandex, Lycra® or elastane and the resin comprises a polyurethane.

In one embodiment, the elastic inner or outer layer according to the present disclosure comprises a combination of a resin and a polymer fabric comprising a plurality of elastomeric fibres. In a preferred embodiment, the elastomeric fibres are provided as copolymer fibres produced from polyurethane and polyethylene glycol and comprising rigid and flexible segments. The elastomeric fibres may be provided in the form of a membrane, such as a portion of elastomeric fabric. Non-limiting examples of elastomeric fabrics are spandex (elastane) and those variations sold under proprietary trade marks such as Lycra, Elaspan, Dorlastan and Linel. Other preferred fibres include silicone rubber, segmented urea/urethane/ether copolymers, and fluorinated resins such as perfluoroalkoxy alkanes (PFA), fluorinated ethylene propylene (FEP) or polytetrafluoroethylene (PTFE).

The elastomeric fibres may be provided in the form of a portion of woven fabric or membrane in which elastomeric fibres are present in at least a small percentage of the total composition of the fabric weave. Desirably, the fabric or membrane can be provided in any size and shape suitable for a specific application. In this manner, the polymer fabric can be applied as a single continuous component.

The portion of polymer fabric may be combined with a resin or resin matrix. The resin may be provided in a liquid form and applied to the polymer fabric. Application of the resin may be as simple as painting the liquid onto the polymer fabric.

The resin may be provided in the form of any suitable liquid resin that may provide qualities of flexibility once the resin has cured or set to a solid form. The cured resin has elastic properties. Non-limiting examples of suitable resins are polyurethanes, polyureas, acrylic resins, polyester resins, silicone resins, fluorinated resins, epoxy resins or combinations thereof.

The reactants necessary in the preparation of the polyurethane resin of the present disclosure comprise:

(i) at least one member selected from among aliphatic and aromatic isocyanates, and
(ii) at least one polymeric polyol, most preferably a member selected from between polyester polyol and polyether polyol, and optionally a chain extender.

The chain extender suitable in the present context is a C2-10 hydrocarbon compound having an isocyanate-reactive chain termination. In a preferred embodiment of the present disclosure, the chain extender is hydroxy and/or an amine terminated. In a further embodiment of the disclosure, additional polyols may be included as reactants.

The isocyanate suitable in the present disclosure is any of the organic isocyanates previously disclosed as suitable in the preparation of polyurethane resins, preferably diisocyanates, and include aliphatic, aromatic and cycloaliphatic diisocyanates, and mixtures thereof.

Illustrative isocyanates but non-limiting thereof are methylene bis(phenylisocyanate) including the 4,4′-isomer, the 2,4′-isomer and mixtures thereof, m- and p-phenylene diisocyanates, chlorophenylene diisocyanates, a,a′-xylylene diisocyanate, 2,4- and 2,6-toluene diisocyanate, toluene diisocyanate, hexamethylene diisocyanate, 1,5-naphthalene diisocyanate, isophorone diisocyanate and the like; cycloaliphatic diisocyanates such as methylene bis(cyclohexyl isocyanate) including the 4,4′-isomer, the 2,4′-isomer and mixtures thereof, and all the geometric isomers thereof including trans/trans, cis/trans, cis/cis and mixtures thereof, cyclohexylene diisocyanates (1,2-; 1,3-; or 1,4-, 1-methyl-2,5-cyclohexylene diisocyanate, 1-methyl-2,4-cyclohexylene diisocyanate, 1-methyl-2,6-cyclohexylene diisocyanate, 4,4′-isopropylidenebis(cyclohexyl isocyanate), 4,4′-diisocyanatodicyclohexyl, and all geometric isomers and mixtures thereof and the like. Also included are the modified forms of methylene bis(phenyl isocyanate). By the latter are meant those forms of methylene bis(phenyl isocyanate) which have been treated to render them stable liquids at ambient temperature (circa 20° C.). Such products include those which have been reacted with a minor amount (up to about 0.2 equivalents per equivalent of polyisocyanate) of an aliphatic glycol or a mixture of aliphatic glycols. Mixtures of any of the above-named isocyanates can be employed if desired.

Preferred classes of organic diisocyanates include the aromatic and cycloaliphatic diisocyanates. Preferred species within these classes are methylene bis(phenyl isocyanate) including the 4,4′-isomer, the 2,4′-isomer, and mixtures thereof, toluene diisocyanate and methylenebis(cyclohexyl isocyanate) inclusive of the isomers described above.

The preferred isocyanates are methylene bis(phenyl isocyanate) (methylene diphenyl isocyanate) and methylene bis(cyclohexyl isocyanate).

The polymeric diols suitable in the context of the present disclosure are those conventionally employed in the art for the preparation of polyurethane resins. The formation of soft segments in the resulting polymer is attributed to the polymeric diols. Preferably, the polymeric diols have molecular weights (number average) within the range of 500 to 10,000, preferably 1000 to 4,000. Naturally, and often times advantageously, mixtures of such diols are also possible. Examples of the suitable diols include polyether diols, polyester diols, hydroxy-terminated polycarbonates, hydroxy-terminated copolymers of dialkyl siloxane and alkylene oxides such as ethylene oxide, propylene oxide and the like, and mixtures thereof.

Examples of suitable polyether polyols include polyoxyethylene glycols, polyoxypropylene glycols which, optionally, have been capped with ethylene oxide residues, random and block copolymers of ethylene oxide and propylene oxide; polytetramethylene glycol, random and block copolymers of tetrahydrofuran and ethylene oxide and/or propylene oxide. The preferred polyether polyols are random and block copolymers of ethylene and propylene oxide of functionality approximately 2.0 and polytetramethylene glycol polymers of functionality about 2.0.

The suitable polyester polyols include the ones which are prepared by polymerizing ε-caprolactone using an initiator such as ethylene glycol, ethanolamine and the like, and those prepared by esterification of polycarboxylic acids such as phthalic, terephthalic, succinic, azelaic and the like acids with polyhydric alcohols such as ethylene glycol, butanediol, cyclohexane-dimethanol and the like. An example of a suitable polyester polyol is butanediol adipate.

Among the suitable amine-terminated polyethers, mention may be made of the aliphatic primary diamines structurally derived from polyoxypropylene glycols.

Examples of polycarbonates containing hydroxyl groups include those prepared by reaction of diols such as propane-1,3-diol, butane-1,4-diol, hexane-1,6-diol, 1,9-nonanediol, 2-methyloctane-1,8-diol, diethylene glycol, triethylene glycol, dipropylene glycol and the like with diaryl-carbonates such as diphenylcarbonate or with phosgene.

Examples of suitable silicon-containing polyethers include copolymers of alkylene oxides with dialkylsiloxanes such as dimethyl-siloxane and the like; other suitable silicon-containing polyethers have been disclosed in U.S. Pat. No. 4,057,595 and in U.S. Pat. No. 4,631,329.

Preferred diols are polyether diols and polyester diols as referred to above.

Suitable chain extenders which are used in the preparation of the polyurethane resin of the disclosure include any of those known in the polyurethane art disclosed above. Typically the extenders may be aliphatic straight and branched chain diols having from 2 to 10 carbon atoms, inclusive, in the chain. Examples of suitable diols include ethylene glycol, 1,3-propanediol, 1,4-butanediol, 1,5-pentanediol, 1,6-hexanediol, neopentyl glycol, and the like; 1,4-cyclohexanedimethanol; hydroquinone-bis-(hydroxyethyl)ether; cyclohexylenediols (1,4-, 1,3-, and 1,2-isomers), isopropylidenebis(cyclohexanols); diethylene glycol, dipropylene glycol, ethanolamine, N-methyldiethanolamine, and the like; and mixtures of any of the above. Minor proportions (less than about 20 equivalent percent) of the difunctional extender may be replaced by trifunctional extenders and/or monofunctional extenders, without adversely effecting the resulting polyurethane resin; illustrative of such extenders are glycerol, trimethylolpropane, and 1-octadecanol and the like.

While any of the dial extenders described and exemplified above can be employed alone, or in admixture, it is preferred to use 1,4-butanediol, 1,6-hexanediol, neopentyl glycol, 1,4-cyclohexanedimethanol, ethylene glycol, and diethylene glycol, either alone or in admixture with each other or with one or more of the aliphatic diols which were named previously. Particularly preferred dials are 1,4-butanediol, 1,6-hexanediol and 1,4-cyclohexanedimethanol. The equivalent proportions of polymeric dial to said extender may vary considerably depending on the desired hardness for the polyurethane resin. In general, the proportions fall within the range of from about 1:1 to about 1:20, preferably from about 1:2 to about 1:10. At the same time, the overall ratio of isocyanate equivalents to equivalents of active hydrogen containing materials is within the range of 0.90:1 to 1.10:1, and preferably, 0.95:1 to 1.05:1.

The preparation of the polyurethane resin of the present disclosure follows procedures and methods which are conventional and which are well known to those skilled in the art. If desired, the polyurethanes can have incorporated in them, at any appropriate stage of preparation, additives such as pigments, fillers, lubricants, stabilizers, antioxidants, coloring agents, fire retardants, and the like, which are commonly used in conjunction with polyurethane resins.

The cure time of the resin may be varied widely by appropriate selection of the resin composition. Preferred cure times are in the range of 30 minutes to 24 hours.

Furthermore, the workability (pot life) of the resin may be varied through selection of the resin composition. Desirable workability is dependent on the particular application in question and preferably will fail within the range of 10 minutes to 1 hour.

Application of the resin to the polymer fabric and subsequent curing of the resin forms a membrane or liner, that is the elastic inner or outer layer. The layer advantageously possesses both qualities of flexibility and elasticity. Furthermore, the combination of the components may impart significant tear resistance in the final layer. It has been found that the elastic inner or outer layer of the present disclosure exhibits tear resistance that is unmatched by traditional elastorneric materials, such as thermoset elastomers. It is apparent that the combination of woven polymer fabric having elastomeric fibres within the resin provides reinforcement to the layer, which advantageously provides a product which has greater tear resistance than materials having no such reinforcement.

Depending on the resin selected, the elastic layer may also have adhesive qualities, assisting in the fixation of the elastic layer directly onto surfaces.

These properties of the elastic inner or outer layer make it suitable for numerous industrial applications, particularly in situations where it is desired to provide sealing, but there are movement issues in respect of the sealing surfaces. The elastic layer, once adhered to the surface, cannot only flex in response to normal thermal expansions and contractions, but also stretches and retracts at the same time. As a result, the elastic layer can appropriately and adequately provide a sealing membrane on a surface or within a hose or pipe while causing no stressing to or upon the surfaces themselves. That is, the elastic layer is able to move in conjunction with normal expansion and contraction of a surface or within the hose or pipe surfaces themselves, resulting in adequate sealing with no stressing or cracking of the surfaces to which the elastic layer has been applied.

Further, the elastic inner or outer layer may advantageously be provided and applied as a single continuous unit, having no joins or breaks to compromise the structural integrity of the overall seal. The preferred method of application of the elastic layer comprises providing a single continuous portion of polymer fabric having elastomeric fibres woven therein. The portion of fabric may be comparable in shape and configuration to the area to which the elastic layer is to be applied. That is, the shape and configuration may accord to the entire area of application of the final seal.

The single continuous polymer fabric portion is placed upon the surface or surfaces requiring sealing. The suitable resin is then applied directly onto the fabric portion. Since the resin may be selected to have required adhesive qualities to enable adhesion to the desired surface, application of the resin to the polymer fabric enables adhesion of the resulting elastic layer to the surface or surfaces.

This method of application advantageously permits direct application at the desired site. Further, the resin may be selected such that it requires no special curing process or application of primers in order to set the final elastic layer as a seal upon surfaces. That is, the resin, once applied to the portion of woven fabric, sets or cures without any special curing methods or application of further products. This is in contrast to traditionally used elastomers such as rubber, which is sticky and can easily deform when warm and is brittle when cold. In this state, in cannot be used to make articles with a good level of elasticity and in any event, if left in a natural state, will eventually disintegrate. Rubber requires treatment by vulcanisation or other curing methods in order to attain good properties of elasticity and flexibility. Such treatment methods are completely unnecessary in application of the present disclosure. Further, elastomers such as rubber have limited or no adhesive qualities and are often unsuitable for attaching directly upon a surface.

While direct application as described above is a preferred method of application of the elastic inner or outer layer, it is also within the scope of the present disclosure to manufacture the elastic layer as a factory prepared unit prior to transportation and installation at the desired location. The woven fabric portion is, as described above, cut out or otherwise provided in a shape and size that may be comparable to the shape and size of the desired final seal. The fabric portion can be arranged upon a mould or other suitable structure that replicates the dimensions and configuration of the structure or structures to which the completed seal is intended to be applied. The resin is applied to the fabric portion as described above, thereby creating a final unit of elastic layer as a single, continuous element having no seams or joins. Advantageously, the pre-formed unit is packed, for example in foil, so as to preserve the resin in an uncured state.

This single pre-formed unit of elastic layer can then be transported and applied to a surface or surfaces as required, such as by adhering the elastic layer in place with the same or similar materials used in its construction. As an example, the resin used in construction of the elastic layer can be applied to the surface or surfaces and the prefabricated polymer fabric unit placed thereupon. The nature of the resin applied to the surface and of the prefabricated unit is such that there is bonding there between, creating the same continuous sealing construction as when the woven fabric and resin are applied directly on site as described above.

To make the elastic inner or outer layer, the binder may be melt coated or extrusion coated onto the polymer fabric. At this stage (before curing), the elastic layer can be introduced inside a hose or pipe. The flexible elastic layer can be inserted by either a drag-in or inversion method, both of which are well known in the art. Inversion is the process where the elastic layer is turned inside-out during the installation using a column of water or pressurized air; the elastic layer walks itself through the host pipe. Inversion results with the exterior coating becoming the new interior pipe wall surface with the elastic layer pressed against the host pipe wall. The inversion process can be performed using air pressure (a shooter or air inverter) or a water column (inversion water column). Once inside the cavity, heat may be applied, if required, by injecting steam and/or hot water to force the elastic layer against the inside of the pipe and to cure in place the resin. The elastic layer can also be inserted into the cavity by use of hot water under pressure. Once the resin is cured, it sets and the elastic layer forms a hose within a hose.

The elastic inner or outer layer can be made to the desired length required to line the hose, and preferably is a continuous tubular liner. The liner should have a length sufficient to line the pipe or hose with one continuous length that is not required to be spliced together from shorter pieces. The liner (elastic layer) will typically be at least 1 meter in length and can be as long as 5000 meters in length. More typically the liners are lengths of from 2 to 1000 meters in length.

The diameter of the liner, once formed into a closed tube will vary depending on the diameter of the cryogenic hose. Typical diameters are from about 5 cm to about 250 cm, but more commonly the diameters are 10 cm to about 50 cm.

The liner can conform to the shape of the inside of the pipe. The shape of the pipe does not need to be perfectly circular, but rather can be non-circular such as egg-shaped or elliptical shaped. The liner can also negotiate bends in the pipe or hose.

After the polymer fabric is impregnated with the resin and the liner (elastic layer) is made, it may be stored at low temperature, either in an ice bath or a refrigerated truck. This cold storage is sometimes necessary to prevent premature curing of the resin, before it is installed. The liner can be brought to the job site in the refrigerated truck to prevent premature curing of the resin. In some instances, the polymer fabric layer may be impregnated with the resin at the job site.

After the liner is inserted into the cryogenic hose, the resin may cure at ambient temperature, or, if required, an elevated temperature. Cure times may vary from 1 to 24 hours. Steam or hot water may be introduced to enhance curing. Steam curing requires less time, usually 3-5 hours as compared to hot water which usually takes 8-12 hours.

It is therefore apparent that the elastic inner or outer layer provides a convenient product that advantageously exhibits features of elasticity, flexibility and tear resistance that has to date not been achieved in any other product, particularly products used in the lining of cryogenic hoses. Further, the present disclosure also provides a convenient method of manufacture and application of the elastic layer to readily and efficiently create a protective barrier in cryogenic hoses.

### EXAMPLES

The following Examples describe the composition of elastic layers according to exemplary embodiments of the present disclosure and are intended to illustrate the disclosure. The Examples are not to be construed as limiting in any way the scope of the present disclosure.

| Example No. | Polymer Fabric | Resin |
|---|---|---|
| 1 | 91% Tactel ® nylon/9% | Polyurethane derived from |
| | Lycra ® fabric weave | MDI (methylene diphenyl |
| | (225 g/m²) | diisocyanate) |
| 2 | 90% nylon/10% elastane | Polyurethane derived from |
| | fabric weave (250 g/m²) | MDI (methylene diphenyl |
| | | diisocyanate) |
| 3 | 91% Tactel ® nylon/9% | Polyurethane derived from TDI |
| | Lycra ® fabric weave | (toluene diisocyanate). |
| | (225 g/m²) | |
| 4 | 90% nylon/10% elastane | Polyurethane derived from TDI |
| | fabric weave (250 g/m²) | (toluene diisocyanate). |

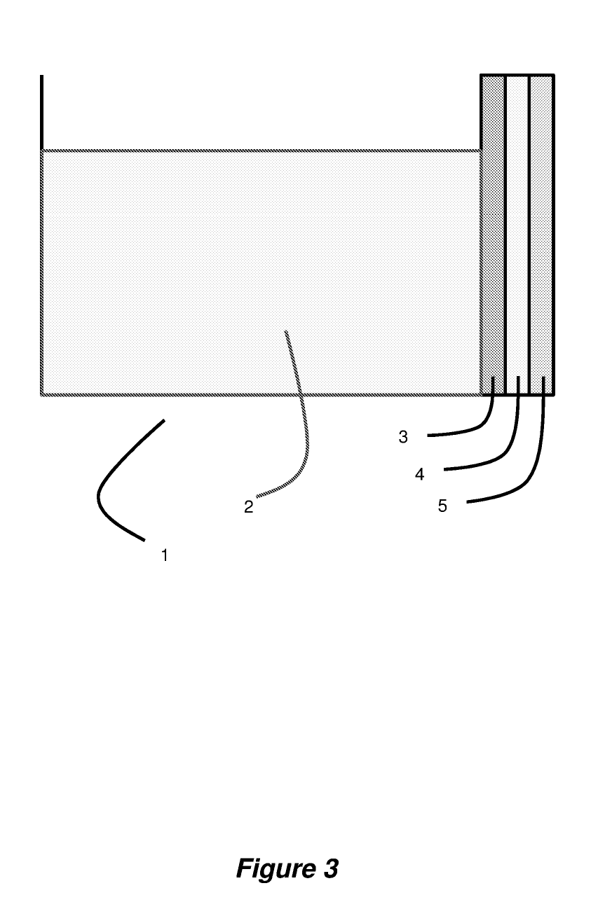

FIG. 3 illustrates a cryogenic liquid vessel (1) according to an embodiment of the present disclosure containing cryogen (2). The vessel has a composite wall structure comprising an inner elastic layer (3) an insulating layer (4) and a structural layer (5).

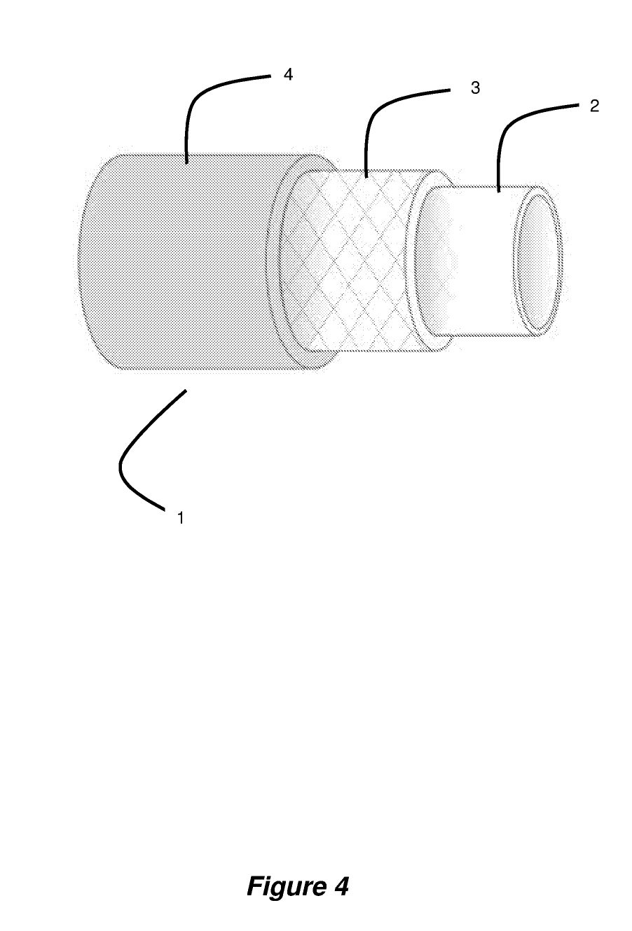

FIG. 4 illustrates a cryogenic liquid transfer hose (1) according to an embodiment of the present disclosure comprising an inner elastic layer according to the present disclosure (2), a metal or metal composite layer (2) and an outer protective or insulating layer (4).

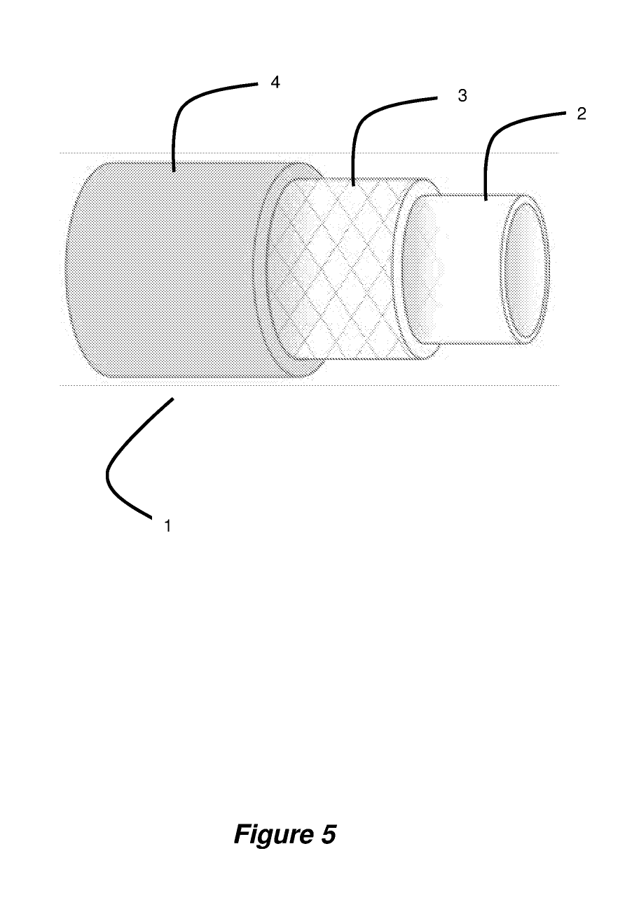

FIG. 5 illustrates a cryogenic liquid transfer hose (1) according to an embodiment of the present disclosure comprising a metal or metal composite layer (2) an insulating layer (3) and an outer elastic layer according to the present disclosure (4).

It is to be understood that while the present disclosure has been described in conjunction with the specific embodiments thereof, the foregoing description is intended to illustrate and not limit the scope of the disclosure. Other aspects, advantages and modifications will be apparent to those skilled in the art to which the disclosure pertains. Therefore, the above examples are put forth so as to provide those skilled in the art with a complete disclosure and description of how to make and use the disclosed devices, and are not intended to limit the scope of the disclosure.

For the sake of brevity, only certain ranges are explicitly disclosed herein. However, ranges from any lower limit may be combined with any upper limit to recite a range not explicitly recited, as well as, ranges from any lower limit may be combined with any other lower limit to recite a range not explicitly recited, in the same way, ranges from any upper limit may be combined with any other upper limit to recite a range not explicitly recited.

All documents cited are herein fully incorporated by reference for all jurisdictions in which such incorporation is permitted and to the extent such disclosure is consistent with the description of the present disclosure.

1-22. (canceled)

23. A cryogenic liquid storage vessel comprising a composite wall structure, said wall structure comprising the following layers:
(a) an elastic inner layer comprising a polymer fabric impregnated with a cured resin;
(b) a structural layer; and
(c) an insulating layer disposed between the elastic inner layer and the structural layer;
wherein the storage vessel is a Full Containment LNG vessel or a Membrane LNG vessel in which the metal walls of said Full Containment LNG vessel or Membrane LNG vessel are replaced by the elastic inner layer;
wherein the elastic inner layer has an elasticity of at least 100%; and
wherein, in use, the elastic inner layer is in direct contact with a cryogenic liquid.

24. The cryogenic storage vessel according to claim 23, wherein the structural layer comprises one or more of concrete, reinforced concrete, carbon fibre, metals, alloys or combinations thereof.

25. The cryogenic storage vessel according to claim 23, wherein the insulating materials comprise one or more of perlite, vermiculite, glass fibres and ceramic fibres.

26. The cryogenic storage vessel according to claim 23, wherein the elastic inner layer provides an impervious or substantially impervious barrier to liquid cryogen.

27. The cryogenic storage vessel according to claim 23, wherein the elastic inner layer has an elasticity of at least 200%, or at least 400%, or at least 600% or at least 800%.

28. The cryogenic storage vessel according to claim 23, wherein the elastic inner layer has an elasticity of at least 100%, or at least 200% at −196° C.

29. The cryogenic storage vessel according to claim 23, wherein the polymer fabric is one or more of spandex (elastane), Lycra®, block copolymers of polyurethane and polyethylene glycol, silicone rubber, segmented urea/urethane/ether copolymers, fluorinated resins such as perfluoroalkoxy alkanes (PFA), fluorinated ethylene propylene (FEP), or polytetrafluoroethylene (PTFE) optionally in combination with one or more synthetic or natural fibres, for example, nylon, polypropylene or polyethylene.

30. A cryogenic liquid storage vessel according to claim 23, wherein the cured resin comprises polyurethanes, polyureas, acrylic resins, polyester resins, silicone resins, fluorinated resins, for example polyvinylidene fluoride (PVDF) and polytetrafluoroethylene (PTFE), fluorinated silicone resins, epoxy resins or combinations thereof.

31. A cryogenic liquid storage vessel according to claim 23, wherein the structural layer comprises concrete.

32. A cryogenic liquid storage vessel according to claim 23, wherein the structural layer comprises carbon fibre.

33. A cryogenic liquid storage vessel according to claim 23, wherein the cured resin comprises a polyurethane.

34. A cryogenic liquid storage vessel according to claim 23, wherein the polymer fabric comprises one or more of spandex, Lycra® or elastane.

35. A cryogenic liquid storage vessel according to claim 23, wherein the polymer fabric comprises nylon and one or more of spandex, Lycra® or elastane.

36. A cryogenic liquid storage vessel according to claim 23, wherein the elastic inner layer has a thickness of less than 5000 microns.

37. A cryogenic liquid storage vessel according to claim 23, wherein the elastic inner layer has a thickness from 100 to 5000 microns.

38. A cryogenic liquid storage vessel according to claim 23, wherein the elastic inner layer has a thickness from 100 to 1000 microns.

39. A cryogenic liquid storage vessel according to claim 23, wherein the elastic inner layer is in direct contact with the insulating layer.

40. A cryogenic liquid storage vessel according to claim 23, wherein the vessel further comprises a liquid cryogen, such as LNG.

41. A cryogenic liquid storage system, said storage system comprising a plurality of cryogenic liquid storage vessels according to claim 23.
